(19) United States
(12) Patent Application Publication
(10) Pub. No.: US 2008/0265849 A1
(43) Pub. Date: Oct. 30, 2008

(54) CONTROL APPARATUS OF POWER CONVERSION CIRCUIT AND CONTROL METHOD THEREOF

(75) Inventor: Jong-Ping Lee, Hsinchu City (TW)

Correspondence Address: J C PATENTS, INC., 4 VENTURE, SUITE 250, IRVINE, CA, 92618, US

(73) Assignee: WINBOND ELECTRONICS CORP., Hsinchu (TW)

(21) Appl. No.: 11/767,952

(22) Filed: Jun. 25, 2007

(30) Foreign Application Priority Data
Apr. 24, 2007 (TW) 96114400

(51) Int. Cl. G05F 1/563

(52) U.S. Cl. 323/238; 323/241; 323/263

(57) ABSTRACT

A control apparatus for a power conversion circuit and a control method thereof are provided. The method of the control apparatus includes producing a first control signal and a second control signal; modulating the first control signal according to an output voltage of the power conversion circuit; detecting the output voltage of the power conversion circuit to attain a detecting result; if the detecting result exhibits the input voltage of the power conversion circuit below a normal operating level, using the second control signal to control the power conversion circuit; or if the detecting result exhibits the input voltage of the power conversion circuit above the normal operating level, using the first control signal to control the power conversion circuit. The duty cycle of the fist control signal is greater than that of the second control signal.

### CROSS-REFERENCE TO RELATED APPLICATION

This application claims the priority benefit of Taiwan application serial no. 96114400, filed on Apr. 24, 2007. All disclosure of the Taiwan application is incorporated herein by reference.

### BACKGROUND OF THE INVENTION

1. Field of the Invention

The present invention relates to a power supply device. More particularly, the present invention relates to a control apparatus of a power conversion circuit and a control method thereof.

2. Description of Related Art

Driven by a control apparatus, a power conversion circuit can convert an input voltage Vin and produce an output voltage Vout. The electric energy needed by a load circuit is provided by the output voltage Vout. The working voltages of the control apparatus and the input voltage of the power conversion circuit can have different voltage sources. It has become a key issue how the control apparatus detects the level of the input voltage Vin received by the power conversion circuit and how to control the power conversion circuit.

FIGS. 1 and 2 are relation diagrams of the power conversion circuit and the control apparatus in the conventional art. Referring to FIG. 1, a control apparatus 100 detects the input voltage Vin of the power conversion circuit 110 starting from an input power end of the power conversion circuit 110. The control apparatus 100 includes a comparator 101, a driver 103, and a driver 105. As shown in FIG. 1, the control apparatus 100 can work when supplied with power by working voltages VCC1 and VCC2, and the working voltages VCC1 and VCC2 are related voltage levels. According to the conventional art, the input voltage Vin is input into the non-inverting input end of a comparator 101 through a current limiting resistor Rs, and the inverting input of the comparator 101 receives a reference level Vinpor. Accordingly, the control apparatus 100 can detect whether the level of the input voltage Vin conforms to the normal operating level by comparing the input voltage Vin and the reference level Vinpor. When the control apparatus 100 detects the input voltage Vin above the reference level Vinpor, it begins to control the power conversion circuit 100 to convert the input voltage Vin and produce the output voltage Vout.

FIG. 2 shows a RT9214 pulse width modulator made by Richtek in the conventional art. Referring to FIG. 2, the conventional pulse width modulator (control apparatus 200) detects the input voltage Vin of the power conversion circuit also starting from an input power end of the power conversion circuit 210. The control apparatus 200 can work when supplied with power by working voltages VCC3 and VCC4, and the working voltages VCC3 and VCC4 are related voltage levels. The control apparatus 200 detects the input voltage Vin by the following principle. A gate control circuit 209 is used to produce a control pulse with a fixed frequency (10 KHz), and a switch S1 and a transistor M1 are enabled through the driver 203. By the use of the switch S1 and the transistor M1, a comparator 201 can compare the input voltage Vin with the reference level 1.5V. A soft start and error logic circuit 207 can detect whether the input voltage Vin has been above 1.5 volts for a determined time by counting the output pulse counts of the comparator 201. According to the detecting result, the soft start and error logic circuit 207 can determine the time of starting the soft start. After completing the soft start, the control apparatus 200 starts to control the power conversion circuit 210 with a normal mode.

It can be known from the two conventional methods that the conventional control apparatuses 100, 200 detect the input voltage Vin starting from an input power end Vin of the power conversion circuits 110, 210. Furthermore, the current control apparatus is highly integrated on an integrated circuit, and the pin number is fixed and limited. However, in the conventional architecture of detecting the input power end of the power conversion circuit, an additional pin is required to detect the input voltage Vin.

Accordingly, the manufactures of the control apparatuses are in urgent need of a proper method for solving the above problems.

### SUMMARY OF THE INVENTION

Accordingly, the present invention is directed to providing a control apparatus of a power conversion circuit and a control method thereof, so as to attain the level of the input voltage by detecting the output voltage of the power conversion circuit. When the control apparatus is disposed on the integrated circuit, a pin is not added for detecting the input voltage, thereby reducing the number of the pins of the integrated circuit.

A control apparatus of a power conversion circuit including a power detecting circuit, a modulation circuit, a waveform generating circuit, and a switching circuit is provided. The power detecting circuit detects the output voltage of the power conversion circuit to attain a detecting result. The modulation circuit outputs a first control signal and modulates the first control signal according to the output of the power conversion circuit. The waveform generating circuit provides a second control signal. The switching circuit is coupled to the power conversion circuit, the modulation circuit, and the waveform generating circuit. If the detecting result exhibits the input voltage of the power conversion circuit below a normal operating level, the switching circuit selects the second control signal to control the power conversion circuit, and if the detecting result exhibiting the input voltage of the power conversion circuit above the normal operating level, the switching circuit selects the first control signal to control the power conversion circuit.

From another point of view, the present invention further provides a control method of a power conversion circuit. The control method includes: producing a first control signal and a second control signal; modulating the first control signal according to the output voltage of the power conversion circuit; detecting the output voltage of the power conversion circuit to attain a detecting result; if the detecting result exhibits the input voltage of the power conversion circuit below a normal operating level, using the second control signal to control the power conversion circuit; if the detecting result exhibits the input voltage of the power conversion circuit above the normal operating level, using the first control signal to control the power conversion circuit. The duty cycle of the first control signal is greater than that of the second control signal to alleviating the transient current variation of the power conversion.

In the control method of the power conversion circuit according to an embodiment, the duty cycle of the second control signal is fixed or increasing.

According the embodiments of the present invention, as the control apparatus and the control method attain the level of the input voltage by detecting the output voltage of the power conversion circuit, the existing feedback pin required for the modulation can be shared to indirectly detect the level of the input voltage, thus it is not necessary to additionally add a pin to serve as the detect pin of the input voltage, thereby reducing the design cost of the integrated circuit. If the detecting result exhibits the input of the power conversion circuit below a normal operating level, a detection mode is used and the second control signal with a smaller duty cycle to control the power conversion circuit. If the detecting result exhibits the input of the power conversion circuit above the normal operating level, a normal mode is restored and the first control signal is used to control the power conversion circuit.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 and 2 are relation diagrams of a conventional power conversion circuit and a control apparatus.

FIG. 3 is a circuit block diagram of relationship between a power conversion circuit and a control apparatus according to an embodiment of the present invention.

FIG. 4 is a circuit relation diagram of a power conversion circuit and a control apparatus according to another embodiment of the present invention.

FIG. 5 is a switching circuit diagram according to another embodiment of the present invention.

FIG. 6 is an oscillogram of FIG. 4.

FIG. 7 is a flow chart of a control method of the power conversion circuit according to another embodiment of the present invention.

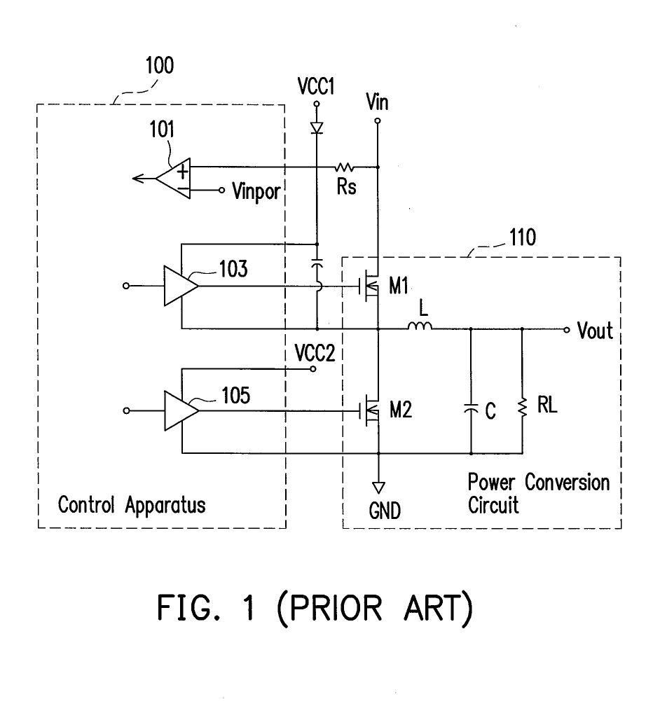

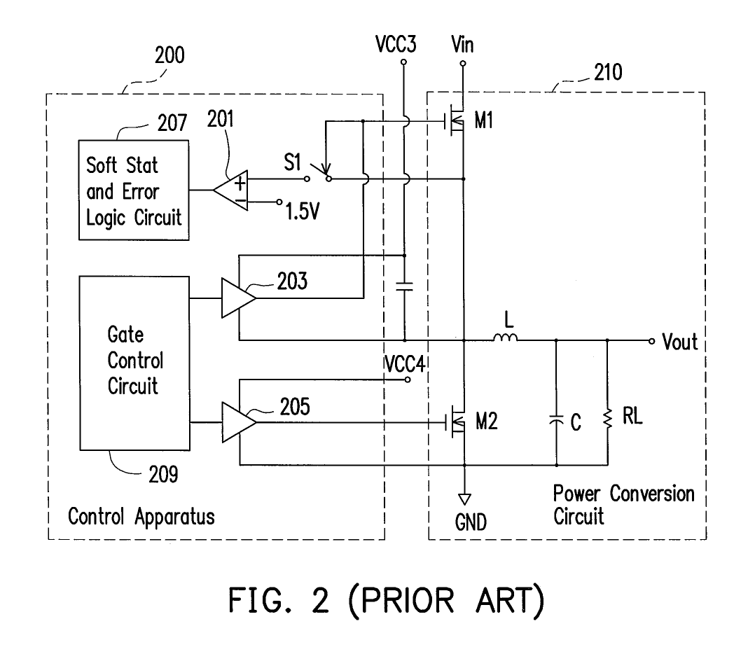

### DESCRIPTION OF EMBODIMENTS

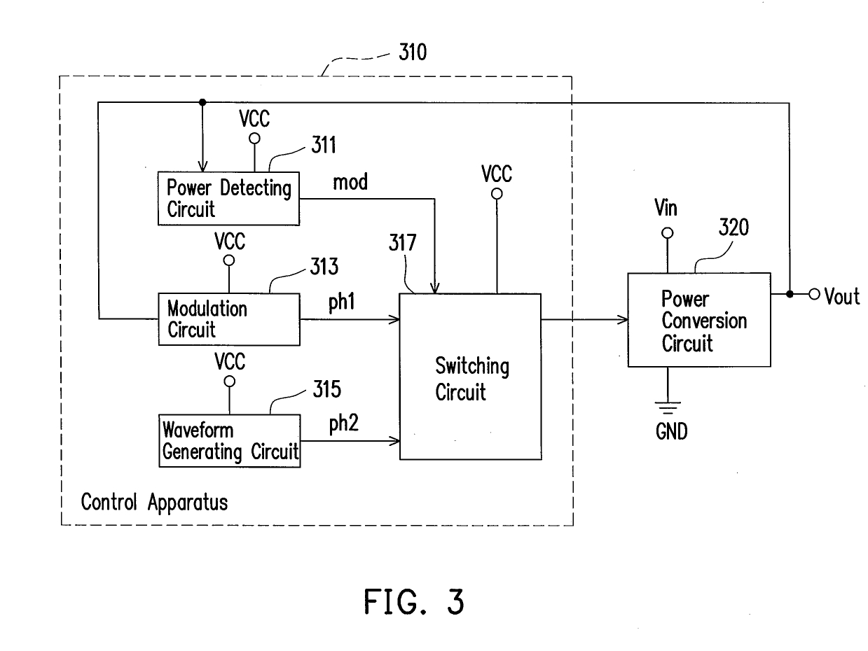

FIG. 3 is a circuit block diagram of relationship between a power conversion circuit and a control apparatus according to an embodiment of the present invention. In the architecture of this embodiment, the working voltage levels of the control apparatus 310 and the power conversion circuit 320 can be different. The working voltage of the power conversion circuit 320 is an input voltage Vin. The working voltage VCC of the control apparatus 310 can be different from the input voltage Vin. The power conversion circuit 320 is controlled by the control apparatus 310 to produce an output voltage Vout. The power conversion circuit 320 can be a buck circuit, a boost circuit, or a buck-boost circuit. The control apparatus 310 of this embodiment detects and determines whether the input voltage Vin of the power conversion circuit 320 is below a normal operating level or not according to the output voltage Vout of the power conversion circuit 320. The control apparatus 310 includes a power detecting circuit 311, a modulation circuit 313, a waveform generating circuit 315, and a switching circuit 317. Hereinafter, this present embodiment is illustrated by various circuit blocks of the control apparatus 310.

In FIG. 3, a modulation circuit 313 outputs a first control signal ph1 and modulates the first control signal ph1 according to the output voltage Vout of the power conversion circuit 320. The modulation circuit 313 modulates the first control signal ph1 by means of pulse width modulation (PWM), pulse frequency modulation (PFM), or other modulation manners.

The power detecting circuit 311 detects the output voltage Vout of the power conversion circuit 320 to attain a detecting result mod. The detecting result mod can exhibit whether the input voltage Vin of the power conversion circuit 320 is below or above a normal operating level, and the normal operating level is set according to the application and requirement of the power conversion circuit 320.

The switching circuit 317 is coupled to the power conversion circuit 320, the modulation circuit 313, the waveform generating circuit 315, and the power detecting circuit 311. If the detecting result mod exhibits the input voltage Vin of the power conversion circuit 320 below the normal operating level, the switching circuit 317 selects the second control signal ph2 to control the power conversion circuit 320 (at this time the control apparatus 310 enters a detection mode). If the detecting result mod exhibits the input voltage Vin of the power conversion circuit 320 above the normal operating level, the switching circuit 317 selects the first control signal ph1 to control the power conversion circuit 320 (and the control apparatus 310 is restored to a normal mode).

The waveform generating circuit 315 produces a second control signal ph2. In consideration of safety and power-saving of initial detection, the duty cycle of the second control signal ph2 according to this embodiment is much less than that of the first control signal ph1. Additionally, the duty cycle of the second control signal ph2 can be fixed or increasing.

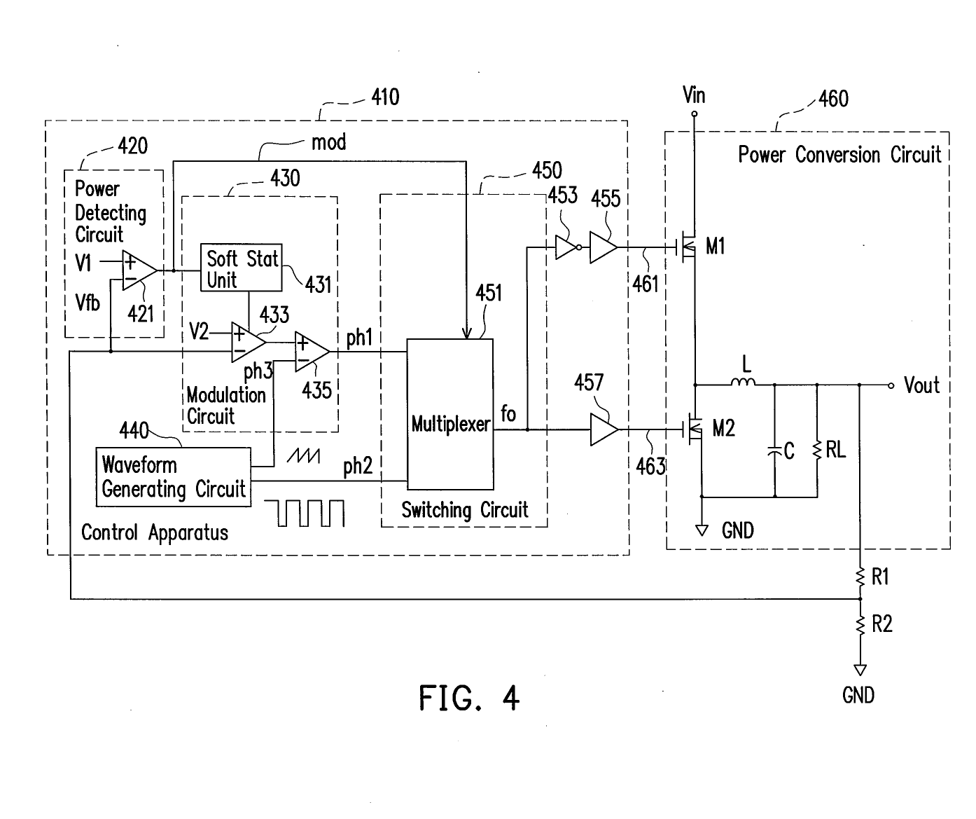

FIG. 4 is a circuit relation diagram of a power conversion circuit and a control apparatus according to another embodiment of the present invention. The various circuit block diagrams in FIG. 3 can be implemented with reference to FIG. 4. Referring to 4, a control apparatus 410 controls a power conversion circuit 460 to convert an input voltage Vin into an output voltage Vout.

For convenience of illustration, it is assumed that the power conversion circuit 460 is a buck circuit. Firstly, the controlled power conversion circuit 460 is illustrated. The controlled power conversion circuit 460 includes N-channel metal-oxide-semiconductor (NMOS) transistors M1 and M2, an inductor L, a capacitor C, and a resistor RL. A drain of the NMOS transistor M1 receives an input voltage Vin, a source of the NMOS transistor M1 is coupled to a drain of the NMOS transistor M2 and a first end of the inductor L. A source of the NMOS transistor M2 is connected to a ground GND. An end of the capacitor C is coupled to a second end of the inductor L and an end of the resistor RL, the other end of the capacitor C and the other end of the resistor RL are connected to the ground GND. Two gates of the NMOS transistors M1 and M2 receive the control signal of the control apparatus 410, and the second end of the inductor L produces an output voltage Vout.

Similarly to FIG. 3, the control apparatus 410 gets the needed operation electric energy from the working voltage VCC (not shown). The control apparatus 410 includes a power detecting circuit 420, a modulation circuit 430, a waveform generating circuit 440, a switching circuit 450, an inverter 453, a driver 455, and a driver 457.

In this embodiment, the control apparatus 410 further includes resistors R1 and resistor R2. A first end of the resistor R1 is coupled to an output end of the power conversion circuit 460 to receive an output voltage Vout. The resistor R2 is coupled between a second end of the resistor R1 and the ground GND. A feedback voltage Vfb is generated at the coupling position of the resistor R1 and the resistor R2 under a voltage division effect. Therefore, the feedback voltage Vfb and the output voltage Vout are in proportion, i.e. Vfb=[R2/(R1+R2)]*Vout. Certainly, in a particular circumstance, the resistor R1 can be 0, and the resistor R2 can be infinite, so that the feedback voltage Vfb is equal to the output voltage Vout.

The power detecting circuit 420 includes a comparator 421. A first input end of the comparator 421 receives a first reference level V1, a second input end of the comparator 421 is coupled to the feedback voltage Vfb. Therefore, the power detecting circuit 420 can produce a detecting result mod from the comparison operation of the comparator 421.

Next, the waveform generating circuit 440 is illustrated. The waveform generating circuit 440 provides a second control signal ph2 and a triangular wave ph3. In this embodiment, the second control signal ph2 can be a square wave, and the triangular wave ph3 can be a sawtooth wave with a regular period.

Then, the modulation circuit 430 is illustrated. The modulation circuit 430 includes a soft start unit 431, an error amplifier 433, and a comparator 435. The soft start unit 431 is coupled between an output end of the power detecting circuit 420 and the error amplifier 433. A first input end of the error amplifier 433 receives a second reference level V2, a second input end of the error amplifier 433 is coupled to a second end of the resistor R1. A first input end of the comparator 435 is coupled to an output end of the error amplifier 433, a second input end of the comparator 435 receives a triangular wave ph3. The soft start unit 431 determines whether or not to actuate the error amplifier 433 according to the detecting result mod output by the power detecting circuit 420. The comparator 435 compares the levels of the output voltage Vc and the triangular wave ph3 of the amplifier 433, and outputs a first control signal ph1 according to the comparing result.

As a band-gap reference voltage is not sensitive to the change of temperature, the second reference level V2 may be a band-gap reference voltage. The level of the first reference level V1 can be designed according to the second reference level V2. For example, we can design a first reference level V1 equal to 30% of the second reference level V2 (i.e. V1=V2*30%). The design ratio 30% can prevent the detecting result mod from being obtained too late. Persons of ordinary skill in the art can adjust the ratio according to the teaching of the embodiments and sprit of the present invention depending on requirements.

The switching circuit 450 is illustrated hereinafter. The switching circuit 450 includes a multiplexer 451. The multiplexer 451 has a first input end, a second input end, a selecting end, and an output end. The first input end and second input end of the multiplexer 451 receive the first control signal ph1 and the second control signal ph2 respectively, the selecting end of the multiplexer receives the detecting result mod of the power detecting circuit 420. If the detecting result mod exhibits the input voltage Vin of the power conversion circuit 460 below the normal operating level (i.e., the feedback voltage Vfb is lower than the reference level V1), the multiplexer 451 selects the second control signal ph2 to control the power conversion circuit 460. If the detecting result mod exhibits the input voltage Vin of the power conversion circuit 460 above the normal operating level (i.e., the feedback voltage Vfb is higher than the first reference level V1), the multiplexer 451 selects the first control signal ph1 to control the power conversion circuit 460.

Accordingly, as described above, the control apparatus 410 further includes an inverter 453, a driver 455, and a driver 457. The inverter 453 is coupled to the output end of the multiplexer 451 to receive the control signal fo selected by the switching circuit 450. An input end of the driver 455 is coupled to an output end of the inverter 453, and an output end of the driver 455 is coupled to the gate of the NMOS transistor M1. An input end of the driver 457 is coupled to the output end of the multiplexer 451, and an output end of the driver 457 is coupled to the gate of the NMOS transistor M2. Therefore, the driver 455 outputs a first driving signal 461 according to the control of the control signal fo (i.e. the control signal ph1 or ph2) to drive the NMOS transistor M1. The driver 457 outputs a second driving signal 463 according to the control of the control signal fo to drive the NMOS transistor M2. In this embodiment, the first driving signal 461 and the second driving signal 463 are mutually inverted in phase and are not overlapped, so as to avoid conducting the NMOS transistor M1 and M2 simultaneously.

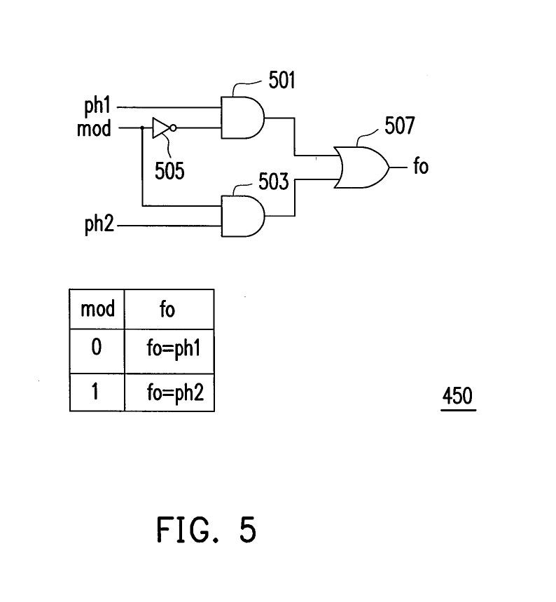

Persons of ordinary skill in the art can implement the switching circuit 450 with other logic gates according to the teaching of the embodiments and the sprit of the present invention depending on requirements. For example, FIG. 5 is a switching circuit diagram according to another embodiment of the present invention. Referring to FIG. 5, the switching circuit 450 includes AND gates 501, 503, an inverter 505, and an OR gate 507. A first input end of the AND gate 501 is coupled to the modulation circuit 430 to receive a first control signal ph1. A first input end of the AND gate 503 receives the detecting result mod of the power detecting circuit 420. A second input end of the AND gate 503 is coupled to the waveform generating circuit 440 to receive the second control signal ph2. An input end of the inverter 505 receives the detecting result mod of the power detecting circuit 420, and an output end of the inverter 505 is coupled to the second input end of the AND gate 501. A first input end of the OR gate 507 is coupled to the output end of the AND gate 501, and a second input end of the OR gate 507 is coupled to an output end of the AND gate 503. Therefore, the output end of the OR gate 507 can be served as the output end of the switching circuit 450.

Provided that the detecting result mod is expressed by logic level, and the switching circuit 450 selects the control signal ph1 or the control signal ph2 to output according to the detecting result mod. When the detecting result mod is equal to logic 0, the switching circuit 450 outputs the first control signal ph1; and when the detecting result mod is equal to logic 1, the switching circuit 450 outputs the second control signal ph2.

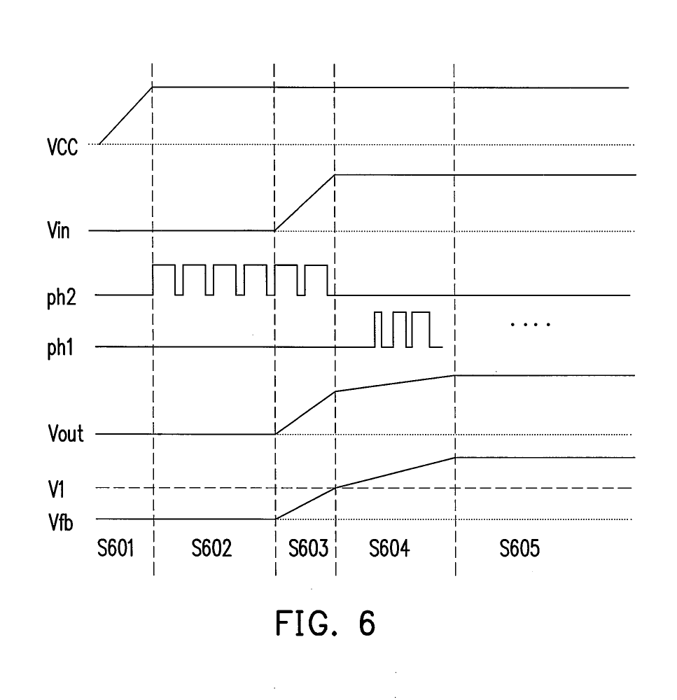

In order to further illustrate the relationship between the control apparatus 410 and power conversion circuit 460, the signal timing of FIG. 4 is illustrated with FIG. 6. The lateral axis in FIG. 6 is time. Referring to FIG. 4 and FIG. 6 together, in this embodiment, the oscillogram in FIG. 6 are divided onto five sections, which are Section S601 to Section S605. In Section S601, no voltage source enough for working is applied on the control apparatus 410 and the power conversion circuit 460, so the control apparatus 410 and the power conversion circuit 460 are in an initial state (i.e. un-start state).

In Section S602, the working voltage VCC reaches a normal operating level, so the control apparatus 410 starts to work. At this time, the switching circuit 450 in initial state selects the second control signal ph2 with a fixed duty cycle to control the power conversion circuit 460. In Section S602, no input voltage Vin is applied on the power conversion circuit 460, so there is no waveform of the output voltage Vout.

In Section S603, an external voltage source starts to provide the input voltage Vin to the power conversion circuit 460. Since the transistors M1 and M2 are controlled by the second control signal ph2 (square wave with a low duty cycle), the output voltage Vout is increased with the rising of the voltage Vin. Therefore, the feedback voltage Vfb is also increased with the rising of the output voltage Vout in a predetermined proportion, until the power detecting circuit 420 detects that the feedback voltage Vfb exceeds the first reference level V1.

As the feedback voltage Vfb exceeds the first reference level V1 (i.e. the input voltage Vin of the power conversion circuit is higher than the normal operating level), the modulation circuit 430 enters a soft start course (i.e. Section S604). In Section S604, the switching circuit 450 is controlled by the detecting result mod to select the first control signal ph1 in stead to control the power conversion circuit 460. The first control signal ph1 can gradually increase the pulse width of the signal ph1 in the modulation manner of FIG. 6. When the feedback voltage Vfb is getting closer to the second reference level V2 (indicating the output of the power conversion circuit 460 becomes stable), the modulation circuit 430 can stop the soft start and enter the normal operation period (i.e. Section S605). In Section S605, the modulation circuit 430 can modulate the pulse width according to feedback voltage Vfb, and output the modulated first control signal ph1 to the switching circuit 450. In Sections S604 and S605, the waveform generating circuit 440 can stop outputting the second control signal ph2 to save power consumption.

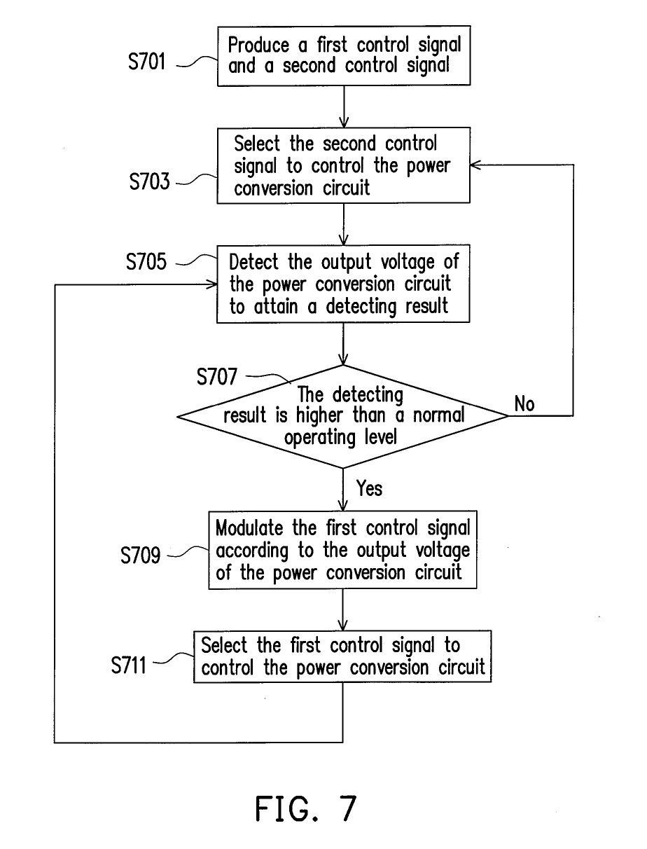

It is should be noted that a control method of the power conversion circuit is included in the above embodiment, referring to FIG. 7 for the convenience of illustration. FIG. 7 is a flow chart of a control method of the power conversion circuit according to another embodiment of the present invention. The control method of the power conversion circuit includes the following steps. In Step S701, in the control method, two control signals are generated, which are the first control signal ph1 and the second control signal ph2 respectively for controlling the power conversion circuit. The second control signal ph2 has the smallest duty cycle. The second control signal ph2 can prevent that the control apparatus when detecting the power conversion circuit produces a high current instantly to burn the power conversion circuit, and can save power consumption during detecting. Accordingly, in Step S703, at the early stage for controlling the power conversion circuit, the second control signal ph2 is used to control the power conversion circuit.

When entering Step S705, the output voltage Vout of the power conversion circuit is detected to attain a detecting result. Next, entering Step S707, a control signal is further selected according to the detecting result. If the detecting result exhibits the input voltage Vin of the power conversion circuit below a normal operating level, return to Step S703, and repeat Step S703 to Step S707. If the detecting result exhibits the input voltage Vin of the power conversion circuit above the normal operating level, perform Step S709.

In Step S709, the first control signal ph1 is modulated according to the output voltage Vout of the power conversion circuit. Next, in Step S711, the power conversion circuit is controlled by the first control signal ph1. Therefore, the output voltage Vout of the power conversion circuit can be maintained stable at a predetermined level. Certainly, when the output of the power conversion circuit reaches a determined value, the output of the power conversion circuit can still be detected continuously. Return to Step S705 to continue Step S705 to Step S711.

In view of the above, in the control apparatus and the control method according to the embodiment of the present invention, an architecture which detects whether an input voltage is applied or not according to the output of the power conversion circuit is adopted. If the detecting result exhibits the input voltage of the power conversion circuit below the normal operating level, the second control signal is selected to control the power conversion circuit. If the detecting result exhibits the input voltage of the power conversion circuit above the normal operating level, the first control signal is selected to control the power conversion circuit. Additionally, when the control apparatus is arranged in the integrated circuit, it is not necessary to additionally add a pin to detect the power, and the already existing feedback pin is directly used to detect the power, thereby reducing the design cost of the integrated circuit, and avoiding the design using an additional pin of the integrated circuit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control apparatus of a power conversion circuit, comprising:
a power detecting circuit, for detecting an output voltage of the power conversion circuit to attain a detecting result;
a modulation circuit, for outputting a first control signal and modulating the first control signal according to an output of the power conversion circuit;
a waveform generating circuit, for providing a second control signal; and
a switching circuit, coupled to the power conversion circuit, the modulation circuit, and the waveform generating circuit, wherein if the detecting result exhibits an input voltage of the power conversion circuit below a normal operating level, the switching circuit selects the second control signal to control the power conversion circuit; or if the detecting result exhibits the input voltage of the power conversion circuit above the normal operating level, the switching circuit selects the first control signal to control the power conversion circuit.

2. The control apparatus of a power conversion circuit as claimed in claim 1, wherein the power detecting circuit comprises:
a first comparator, having a first input end, a second input end, and an output end, wherein the first input end of the first comparator receives a first reference level, the second input end of the first comparator is coupled to a feedback voltage, the output end of the first comparator is used to output the detecting result, and the feedback voltage is in proportion to the output voltage of the power conversion circuit.

3. The control apparatus of a power conversion circuit as claimed in claim 1, further comprising:
a first resistor, having a first end for receiving the output voltage of the power conversion circuit; and
a second resistor, having a first end coupled to the second end of the first resistor and a second end grounded.

4. The control apparatus of a power conversion circuit as claimed in claim 3, wherein the modulation circuit comprises:
a soft start unit, coupled to the output end of the power detecting circuit;
an error amplifier, having a first input end for receiving a second reference level and a second input end coupled to the second end of the first resistor, wherein the soft start unit determines whether or not to start the error amplifier according to a detecting result output by the power detecting circuit; and
a second comparator, having a first input end coupled to the output end of the error amplifier, a second input end for receiving a triangular wave, and an output end for outputting the first control signal.

5. The control apparatus of a power conversion circuit as claimed in claim 4, wherein the second reference level is a band-gap reference voltage.

6. The control apparatus of a power conversion circuit as claimed in claim 1, wherein the waveform generating circuit further provides the triangular wave.

7. The control apparatus of a power conversion circuit as claimed in claim 1, wherein a duty cycle of the second control signal is fixed or increasing.

8. The control apparatus of a power conversion circuit as claimed in claim 1, wherein the switching circuit comprises:
a multiplexer, having a first input end and a second input end for receiving the first control signal and the second control signal respectively and a selecting end for receiving the detecting result of the power detecting circuit, wherein if the detecting result exhibits the input voltage of the power conversion circuit below the normal operating level, the multiplexer selects the second control signal to control the power conversion circuit; if the detecting result exhibits the input voltage of the power conversion circuit above the normal operating level, the multiplexer selects the first control signal to control the power conversion circuit.

9. The control apparatus of a power conversion circuit as claimed in claim 1, wherein the switching circuit comprises:
a first AND gate, having a first input end coupled to the modulation circuit for receiving the first control signal;
a second AND gate, having a first input end for receiving the detecting result of the power detecting circuit and a second input end coupled to the waveform generating circuit for receiving the second control signal;
a second inverter, having an input end for receiving the detecting result of the power detecting circuit and an output end coupled to the second input end of the first AND gate; and
an OR gate, having a first input end coupled to the output end of the first AND gate, a second input end coupled to the output end of the second AND gate, and an output end serving as the output end of the switching circuit.

10. The control apparatus of a power conversion circuit as claimed in claim 1, further comprising:
a first inverter, having an input end coupled to the output end of the switching circuit;
a first driver, having an input end coupled to the output end of the first inverter and an output end coupled to the power conversion circuit; and
a second driver, having an input end coupled to the output end of the switching circuit and an output end coupled to the power conversion circuit.

11. The control apparatus of a power conversion circuit as claimed in claim 1, wherein the power conversion circuit is a buck circuit.

12. The control apparatus of a power conversion circuit as claimed in claim 1, wherein the power conversion circuit is a boost circuit.

13. The control apparatus of a power conversion circuit as claimed in claim 1, wherein the power conversion circuit is a buck-boost circuit.

14. A method of controlling a power conversion circuit, comprising:
producing a first control signal and a second control signal;
modulating the first control signal according to an output voltage of the power conversion circuit;
detecting an output voltage of the power conversion circuit to attain a detecting result;
if the detecting result exhibits an input voltage of the power conversion circuit below a normal operating level, the second control signal is used to control the power conversion circuit; and
if the detecting result exhibits the input voltage of the power conversion circuit above the normal operating level, the first control signal is used to control the power conversion circuit;
wherein a duty cycle of the first control signal is greater than that of the second control signal.

15. The method of controlling a power conversion circuit as claimed in claim 14, wherein a duty cycle of the second control signal is fixed or increasing.
